(19) United States
(12) Patent Application Publication
(10) Pub. No.: US 2007/0184209 A1
(43) Pub. Date: Aug. 9, 2007

(54) Coating method of material for inkjet printing

(75) Inventor: Didier J. Martin, Givry (FR)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/349,375

(22) Filed: Feb. 7, 2006

(51) Int. Cl. B05D 3/00; H05H 1/00

(52) U.S. Cl. 427/535; 427/398.1

(57) ABSTRACT

The present invention relates to a new coating method of a material intended for inkjet printing enabling high coating speeds while reducing or eliminating coating faults. The coating method of a material intended for forming images by inkjet printing comprises heating a composition intended to form the ink-receiving layer, the composition comprising at least one polysaccharide, polyvinyl alcohol, guar gum and inorganic particles having neutral or positive surface charge; treating a support by corona discharge; coating the composition directly on the treated support, using a coating machine in which the support runs; cooling the resulting coated, treated support to obtain the thermoreversible gelation of the composition; and drying the coated, treated support.

### CROSS REFERENCE TO RELATED APPLICATIONS

Reference is made to commonly assigned, co-pending U.S. patent applications:
Ser. No. ______ by Didier Martin (Docket 88479) filed of even date herewith entitled “POLYSACCHARIDE MATERIALS WITH HYDROXYLATED POLYMERS IN INK RECEIVING MEDIA”;
Ser. No. ______ by Didier Martin (Docket 86917) filed of even date herewith entitled “MATERIAL FOR FORMING IMAGES BY INKJET PRINTING”;
Ser. No. ______ by Didier Martin (Docket 86918) filed of even date herewith entitled “MATERIAL FOR FORMING IMAGES BY INKJET PRINTING”; and
Ser. No. ______ by Didier Martin (Docket 91932) filed of even date herewith entitled “GELS OF POLYSACCHARIDE, FLUORINATED SURFACTANT AND PARTICLES”, the disclosures of which are incorporated herein by reference.

### FIELD OF THE INVENTION

The present invention relates to a coating method of a material intended for forming images by inkjet printing.

### BACKGROUND OF THE INVENTION

Digital photography has been growing fast for several years and the general public now has access to efficient and reasonably-priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced through one or more nozzles so that the ink is transformed into a flow of droplets. In order to obtain the most regular sizes and spacing between drops, regular pressure pulses are sent using, for example, a piezoelectric crystal in contact with the ink with high frequency (up to 1 MHz) alternating current (AC) power supply. So that a message can be printed using a single nozzle, every drop must be individually controlled and directed. Electrostatic energy is used for this purpose: an electrode is placed around the ink jet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of the plates. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the basis of inkjet printers used in office automation. With this method, the pressure in the ink cartridge is not maintained constant but is applied when a character has to be formed. In one widely used system, there is a row of twelve open nozzles, each of them being activated with a piezoelectric crystal. The ink contained in the head is given a pulse: the piezo element contracts with an electric voltage, which causes a decrease of volume, leading to the expulsion of the drop by the nozzle. When the element resumes its initial shape, it pumps the ink necessary for new printings into the reservoir. The row of nozzles is thus used to generate a column matrix, so that no deflection of the drop is necessary. One variation of this system replaces the piezoelectric crystals by small heating elements behind each nozzle. The drops are ejected following the forming of bubbles of solvent vapor. The volume increase enables the expulsion of the drop.

Finally, there is a pulsed inkjet system in which the ink is solid at ambient temperature. The print head thus has to be heated so that the ink liquefies and can print. This enables rapid drying on a wider range of products than conventional systems.

New “inkjet” printers capable of producing photographic images of excellent quality are now available. However, they cannot supply good proofs if inferior quality printing paper is used. The choice of printing paper is fundamental for the quality of the resulting image. The printing paper must combine the following properties: high-quality printed image, rapid drying during printing, good image colorfastness over time, and smooth and glossy appearance.

In general, the printing paper comprises a support coated with one or more layers according to the properties required. It is possible, for example, to apply on a support an etch primer layer, an absorbent layer, an ink dye fixing layer and a protective layer or surface layer to provide the glossiness of the material. The absorbent layer absorbs the liquid part of the water-based ink composition after creation of the image. Elimination of the liquid reduces the risk of ink migration to the surface. The ink dye fixing layer prevents any dye loss into the fibers of the paper base, to obtain good color saturation while preventing excess ink that would encourage the increase in size of the printing dots and therefore reduce image quality. The absorbent layer and fixing layer can also constitute a single ink-receiving layer accomplishing both functions. The protective layer is designed to ensure protection against fingerprints and the pressure marks of the printer feed rollers.

The ink-receiving layer usually comprises a binder, a receiving agent and various additives. The purpose of the receiving agent is to fix the dyes in the printing paper. The best-known inorganic receivers are colloidal silica or boehmite. For example, the European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispal™ (colloidal boehmite) marketed by Sasol.

Furthermore, polyvinyl alcohol is generally used as binder. As this binder does not ensure the adhesion of the ink-receiving layer to the support, the combination of poly(alcohol) with hardeners, such as DHD (dihydroxydioxane) or sodium tetraborate (borax) is well known, especially in U.S. Pat. No. 6,419,987. The disadvantage of these hardeners is that they can lead to unwanted reactions that result in a residual tint of the ink-receiving layer. Hardeners also tend to migrate, which can cause crosslinking in the surface of the ink-receiving layer, thus obstructing ink absorption.

Another solution to improve the adhesion of the ink-receiving layer is to apply to the support an undercoat layer of gelatin, on to which the ink-receiving layer will be coated.

However, when the composition intended to form the ink-receiving layer is coated at very high speed to increase productivity and reduce costs, there is significant trapping of air, which causes coating faults when the composition dries, also related to the presence of the inorganic particles and to interactions with the gelatin undercoat layer. These faults can visibly alter the final quality of the printed image. The use of polyvinyl alcohol thus requires specific coating conditions that do not enable either cost reductions or productivity increases.

### PROBLEM TO BE SOLVED

Thus it is necessary to propose a new coating method of a material intended for forming images by inkjet printing enabling high coating speeds while reducing or eliminating the coating faults observed with known coating methods.

### SUMMARY OF THE INVENTION

The present invention relates to a coating method of a material intended for forming images by inkjet printing comprising:
a) heating a composition intended to form the ink-receiving layer, the composition comprising at least one polysaccharide, polyvinyl alcohol, guar gum and inorganic particles having neutral or positive surface charge,
b) treating a support by corona discharge,
c) coating the composition directly on the treated support, using a coating machine in which the support runs,
d) cooling the resulting coated, treated support to obtain the thermoreversible gelation of the composition, and
e) drying the coated, treated support.
   The invention also relates to a coating method of a material intended for forming images by inkjet printing comprising:
a) heating a composition intended to form an ink-receiving layer, the composition comprising at least one carrageenan, polyvinyl alcohol, guar gum and inorganic particles having neutral or positive surface charge,
b) treating a support by corona discharge,
c) coating the composition directly on the treated support, using a coating machine in which the support runs,
d) cooling the resulting material to obtain the thermoreversible gelation of the composition, and
e) drying the material.

### ADVANTAGEOUS EFFECT OF THE INVENTION

The present invention includes several advantages, not all of which are incorporated in a single embodiment. The use of the combination of carrageenan, polyvinyl alcohol and guar gum enables the high-speed coating of a support previously treated by corona discharge, without it being necessary to provide a gelatin undercoat layer, even without the use of hardeners. The resulting material comprises an ink-receiving layer having good adhesion to the support. Furthermore, the setting of the composition intended to form the ink-receiving layer before its drying enables an ink-receiving layer having great surface uniformity to be obtained. The printed image is thus high-quality. The combination of carrageenan, polyvinyl alcohol and guar gum advantageously enables replacement of the gelatin generally used as binder in the ink-receiving layers of inkjet printing paper and which has the disadvantage of swelling in contact with ink drops.

### DETAILED DESCRIPTION OF THE INVENTION

The present invention proposes a new coating method of a material for use in inkjet printing, which comprises a support and at least one ink-receiving layer, by heating a composition comprising at least one polysaccharide, most preferably carrageenan, and polymer comprising hydroxyl groups, preferably polyvinyl alcohol, guar gum, and inorganic particles having neutral or positive surface charge, treating the support by corona discharge, coating the liquid composition directly on the treated support, using a coating machine in which the support runs, cooling the resulting material to obtain the thermoreversible gelation of the composition, and drying the material.

Preferably, treatment of the support by corona discharge according to step b) is performed immediately before the coating on the support according to step c), for example in an on-line installation. Preferably, the support runs at a coating speed greater than or equal to 10 m/min.

The use of the carrageenan, polyvinyl alcohol and guar gum composition enables the coating of the composition directly on the support at high speed and obtains an ink-receiving layer having good adhesion on the support. The method according to the invention eliminates the gelatin undercoat layer and thus the faults related to interactions with this undercoat layer. The resulting ink-receiving layer thus has great uniformity, and results in a high-quality printed image.

The material intended for forming images by inkjet printing used in the present invention comprises firstly a support. This support is selected according to the desired use. It can be a transparent or opaque thermoplastic film, in particular a polyester base film such as polyethylene terephthalate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and their mixtures. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute a material intended for inkjet printing.

According to the coating method of the present invention, the surface of the support is subjected to a preliminary treatment by corona discharge to improve its adhesion properties, before applying the ink-receiving layer directly to the support.

While coating methods known to the prior art provide coatings on at least one side of the support that is used with a very thin undercoat layer of gelatin or another composition to ensure the adhesion of the first layer on to the support, the coating method according to the present invention eliminates this gelatin undercoat layer. Thus, in accordance with the invention, the composition intended to form the ink-receiving layer is applied directly on to the support treated by corona discharge, without it being necessary to apply an intermediate undercoat layer. Preferably, the treatment of the support by corona discharge is performed immediately before coating the composition intended to form the ink-receiving layer on to the support, for example by means of an on-line installation.

According to the invention, the composition intended to form the hydrophilic ink-receiving layer comprises at least one hydrophilic polysaccharide, most preferably carrageenan, and at least one hydrophilic polymer comprising hydroxyl groups, typically polyvinyl alcohol and guar gum, and inorganic particles having neutral or positive surface charge.

Carrageenan is typically made from dried extracts of red seaweed (rhodophyceae). carrageenans are linear polysaccharides made up of more or less substituted galactose units. The chain is made up of subunits called carrabioses comprising two galactose units bound by a β (1-4) linkage. These carrabioses are bound together in the chain by α (1-3) linkages. Furthermore, the galactose units are either esterified by sulfuric acid, or have an oxygen bridge between carbons 3 and 6. Carrageenans are polymers made up of more than 1000 galactose residues (units). There are three main types of carrabiose: κ-carrabiose, ι-carrabiose, and λ-carrabiose, corresponding to the three main types of carrageenans: κ-carrageenan, a polysaccharide made up of n units of κ-carrabiose, ι-carrageenan, a polysaccharide made up of n units of ι-carrabiose, and λ-carrageenan, a polysaccharide made up of n units of λ-carrabiose.

According to the present invention, the carrageenan is selected from among the group comprising the κ-carrageenans, the ι-carrageenans or a combination of these compounds. Preferably, the carrageenan comprises at least 80% κ-carrageenan. According to an especially preferred variant, carrageenan is a pure κ-carrageenan. Carrageenan acts as a gelating agent enabling thermoreversible gelation of the composition intended to form the ink-receiving layer.

According to the invention, the ink-receiving layer comprises at least one polymer comprising hydroxyl groups. The polymer is most desirably water soluble and/or hydrophillic. Preferably, the polymer comprising the hydroxyl groups is selected from among the group including polyvinyl alcoholvinyl alcohol and guar gum, or a mixture of these polymers. Polyvinyl alcohol is used as binder and guar gum is used as co-binder. Guar gum enables the phenomena of syneresis and the material's rheological characteristics to be controlled, and enables the viscosity of the composition intended to form the ink-receiving layer to be reduced. Polyvinyl alcohol enables the gel strength to be increased, syneresis phenomena to be reduced in synergy with the guar gum, in order to obtain good mechanical properties such as adhesion and absence of crackle, and a gloss appearance. Preferably, polyvinyl alcohol has molecular weight greater than 55,000, and preferably greater than 100,000.

Preferably, the composition intended to form the ink-receiving layer comprises less than 1% by weight of carrageenan. Preferably, the quantity of carrageenan is between 0.05% and 0.7% by weight. Preferably, the quantity of carrageenan is between 0.05% and 0.12% by weight. Preferably, the weight ratio of the guar gum to carrageenan is between 1:20 and 1:5, and preferably between 1:10 and 1:5.

Preferably, the composition intended to form the ink-receiving layer comprises between 0.3% and 5% by weight of polyvinyl alcohol, and preferably between 1% and 3%, and preferably between 1.2% and 1.5% by weight.

Preferably, the composition intended to form the ink-receiving layer comprises less than 40% by weight, and preferably between 13% and 33% by weight of inorganic particles. Preferably the inorganic particles, also referred to as fillers, are porous. As the inorganic particles have a neutral surface charge, they can be calcium carbonate and barium sulfate. Inorganic particles having a positive surface charge can be zinc oxides, aluminas, zeolites, aluminosilicates, and modified silicas.

The composition of the coating intended to form the ink-receiving layer is produced by mixing the inorganic particles, water, carrageenan and guar gum with heating. Then polyvinyl alcohol is added and the composition is stirred to obtain a uniform solution. The composition can also comprise a surfactant to improve its coating properties. The composition is then coated on the support previously treated by corona discharge according to a coating method using a coating machine in which the support runs, such as curtain or meniscus coating. Preferably, the support runs at a coating speed greater than or equal to 10 m/min, preferably greater than or equal to 20 m/min. According to the coating machine, it is possible to use coating speeds greater than or equal to 50, 100 or 150 m/min. The composition is applied with a thickness between approximately 200 μm and 400 μm in the wet state. The composition forming the ink-receiving layer can be applied to both sides of the support. It is also possible to provide an antistatic or anti-roll layer on the back of the support coated with the ink-receiving layer.

The resulting material is then cooled to obtain gelation of the composition coated on the support. Preferably, cooling takes place immediately after the coating step and causes the immediate gelation of the composition coated on the support intended to form the ink-receiving layer.

Then, the resulting material is dried. Because of the gelation and the setting of the composition intended to form the ink-receiving layer, the material can be dried in a dryer in which the supports run vertically (loop dryer), which enables the drying speed to be increased, and thus productivity.

The use of the combination of carrageenan, polyvinyl alcohol and guar gum enables the high-speed coating of a support previously treated by corona discharge, without it being necessary to provide a gelatin undercoat layer, with a composition intended to form an ink-receiving layer including a large amount of inorganic particles. The resulting material comprises an ink-receiving layer having good adhesion. Furthermore, the setting of the composition intended to form the ink-receiving layer before its drying enables an ink-receiving layer having great surface uniformity to be obtained. The printed image is thus high-quality. As the resulting material has good adhesion properties between the receiving layer and the support, it is no longer necessary to use hardeners. The combination of carrageenan, polyvinyl alcohol and guar gum advantageously enables replacement of the gelatin generally used as binder in the ink-receiving layers of inkjet printing paper and which has the disadvantage of swelling in contact with ink drops.

### EXAMPLES

The following examples illustrate the present invention without however limiting the scope.

1) Preparing Compositions Intended to be Coated on a Support to Constitute an Ink-Receiving Layer

Unless otherwise stated, all the percentages given are by weight.

Composition 1:

The porous inorganic particle used was an alumina Pural® 200 (boehmite) marketed by SASOL, having a specific surface of 110 m²/g.

Polyvinyl alcohol (PVA) Gohsenol GH17 marketed by Nippon Goshei in 9% solution was used as binder. PVA GH17 has a molecular weight of 98,000. 10G marketed by Olin in 20% aqueous solution was used as surfactant. 1,4-dioxane-2,3-diol (DOD) (ref. 256242) and boric acid (ref. 202878) supplied by ALDRICH were used as hardeners.

Composition 1 contained:

Deionized water=32.27 g

Pural® 200=33 g

PVA GH17=32 g

DOD=0.18 g

Boric acid=0.05 g

10G=2.5 g

Composition 1 contained 33% of inorganic particles and 2.88% of PVA.

The mixture of the inorganic particle with the PVA was stirred vigorously and heated to 60° C. The other compounds were then added in the above order.

Composition 2:

Pure κ-carrageenan Satiagel™ ME5 marketed by Degussa in 1% aqueous solution was used. This solution was prepared by mixing the carrageenan powder in hot deionized water (80° C.) with vigorous stirring.

Guar gum Viscogum™ BCR 13/80 marketed by Degussa in 1% aqueous solution was used. This solution was prepared by mixing the guar gum powder in hot deionized water (80° C.) with vigorous stirring. Polyvinyl alcohol (PVA) Gohsenol GH23 marketed by Nippon Goshei in 9% solution was used as binder. PVA GH23 has a molecular weight greater than 100,000.

Composition 2 contained:

Deionized water=45.76 g

Pural® 200=32.9 g

Satiagel™ ME5=5.01 g

Viscogum=0.5 g

PVA GH23=13.33 g

10G=2.5 g

Composition 2 was comprised 32.9% of inorganic particles, 0.05% of carrageenan, 0.005% of guar gum and 1.2% of PVA.

The inorganic particle Pural® 200 was dissolved in deionized water with magnetic stirring at ambient temperature. Then the mixture was heated to 80° C. with steady stirring. The Satiagel™ ME5 solution was added with the solution of guar gum Viscogum™ BCR 13/80. Polyvinyl alcohol was added at 80° C. with efficient stirring. The mixture was cooled to 50° C. and the stirring was reduced to introduce the surfactant 10G. Deionized water was added to make up to 100 g. The mixture was heated to 50° C. and stirred for 30 minutes at 8000 rpm to obtain a very uniform mixture.

Composition 3:

58.5 ml deionized water were added to 23.5 g of a solution of Satiagel™ ME5 at 3% by weight, with magnetic stirring and heating at 60° C. 16.5 g of a solution of PVA GH23 at 9% by weight were added, and the mixture was stirred for 30 min. To improve the uniformity of the coating, 1.5 g of surfactant solution 10G at 20% by weight were introduced. The mixture was cooled at ambient temperature. It was made up with enough deionized water to obtain 100 g of mixture.

Composition 4:

Composition 2 was repeated by replacing pure κ-carrageenan Satiagel™ ME5 by Satiagel™ AMP 45, combination of κ-carrageenan and ι-carrageenan (approx. 95/5).

Composition 4 was comprised 32.9% of inorganic particles, 0.05% of carrageenan, 0.005% of guar gum and 1.2% of PVA.

Composition 5:

Composition 2 was repeated by replacing pure κ-carrageenan Satiagel™ ME5 by a pure ι- carrageenan, Satiagel™SIA.

Composition 5 was comprised 32.9% of inorganic particles, 0.05% of carrageenan, 0.005% of guar gum and 1.2% of PVA.

2) Coating the Compositions on a Support Including a Gelatin Undercoat Layer

For comparison, compositions 1 to 3 were coated using a pilot meniscus coating machine, with a conventional loop drier, in which the support runs at speeds between 5-20 m/min. The compositions are applied to a Resin Coated Paper type support previously coated with a very thin layer of gelatin, and having undergone a preliminary treatment by corona discharge using an apparatus SOFTAL Gen 3003, output power 1.4 kVA, frequency 20 kHz, high voltage 10-14 kV.

The coating conditions are given in Table I below:

TABLE I

| Parameters | Values |
|---|---|
| Distance between the die and | 200 μm |
| the running support | |
| Coating speed | 5-20 m/min |
| Temperature of the | 50° C. |
| composition | |
| Temperature of the layer | 50° C. |
| Setting temperature | 4° C. |
| Coated width | 0.105 m |
| Wet coated quantity | 117 ml/m² |

The coating quality for compositions 1-3 coated, cooled and dried was observed, according to the coating speed.

The results are given in Table II below:

TABLE II

| | Composition 1 | | | | Composition 2 | | | | Composition 3 | | | |
|---|---|---|---|---|---|---|---|---|---|---|---|---|
| | Coating speed m/min | | | | | | | | | | | |
| Parameters | 5 | 7 | 10 | 20 | 5 | 7 | 10 | 20 | 5 | 7 | 10 | 20 |
| Quality | H | H | H | P | H | H | P | P | H | H | H | H |
| Faults | 0 | 0 | 0 | L | 0 | 0 | L | L | 0 | 0 | 0 | 0 |

H = High coating quality, with good thickness uniformity, without coating faults
P = Poor coating quality, with uneven coated layer, due to coating faults
L = lines separated by non-coated zones due to uneven coating: main coating fault observed

These comparative examples, produced on a support comprising a gelatin undercoat layer, show that for Composition 1, including a hardener, the maximum acceptable coating speed is 10 m/min to ensure high-quality coating. For Composition 2, the acceptable coating speed is less than 10 m/min. This speed limitation is due to trapped air causing the appearance of faults like lines separated by uncoated zones. Whereas no line is observed for Composition 3 even at a coating speed of 20 m/min. This is explained by the fact that Composition 3 does not include any inorganic particle. Thus there is no interaction with the gelatin undercoat layer.

3) Coating the Compositions on a Support not Including a Gelatin Undercoat Layer

The coating method according to the invention was operated using Composition 2. For comparison, a similar method is applied with Composition 1. Compositions 1 and 2 were coated using a pilot meniscus coating machine, with a conventional loop drier, in which the support runs at speeds between 5-20 m/min. The compositions were applied on a Resin Coated Paper type support having undergone a preliminary treatment by corona discharge but not including a gelatin undercoat layer. The coating conditions were those given in Table I below. The coating quality for compositions 1-2 coated, cooled and dried to form the ink-receiving layer was observed, according to the coating speed.

The results are given in Table III below:

TABLE III

| | Composition 1 | | | | Composition 2 | | | |
|---|---|---|---|---|---|---|---|---|
| | (comp.) | | | | (Inv.) | | | |
| | Coating speed m/min | | | | | | | |
| Parameters | 5 | 7 | 10 | 20 | 5 | 7 | 10 | 20 |
| Quality | H | H | H | P | H | H | H | H |
| Faults | 0 | 0 | 0 | L | 0 | 0 | 0 | 0 |

H = High quality coating, with good uniformity of thickness, without coating faults
P = Poor quality coating, with uneven coated layer, due to coating faults
L = Lines separated by uncoated zones due to uneven coating: main coating fault observed

The comparative example from Composition 1 shows that the maximum acceptable coating speed is 10 m/min to ensure high-quality coating, the result being the same whether the support has an undercoat layer of gelatin or not. On the other hand, the example according to the invention from Composition 2 shows that, on a support not including a gelatin undercoat layer, the combination of carrageenan, polyvinyl alcohol and guar gum enables the coating speed to be increased significantly to 20 m/min being the maximum speed of the pilot machine) instead of 7 m/min, while obtaining very high-quality coating.

4) Very High-Speed Coating of the Compositions on a Support not Including a Gelatin Undercoat Layer

The coating method according to the invention was operated using 15 kg of Composition 2. For comparison, a similar method is applied with Composition 1. Compositions 1 and 2 were coated using a meniscus coating machine, with a conventional loop drier, in which the support runs at high speeds between 0 and 150 m/min. The suction rate varied between 100 and 300 Pa and the distance between the die and the running support varied between 200 and 275 μm. The other coating conditions were those given in Table I below.

Compositions 1 and 2 were applied on a Resin Coated Paper type support having undergone a preliminary on line treatment by corona discharge but not including a gelatin undercoat layer. The coating quality for compositions 1-2 coated, cooled and dried to form the ink-receiving layer was observed, according to the coating speed. The results are given in Table IV below for Composition 1 and in Table V below for Composition 2:

TABLE IV

| Distance between the | Coating | | | |
|---|---|---|---|---|
| die and the running | speed | Composition 1 | | |
| support (μm) | (m/min) | (Comp.) | | |
| 200 | 15 | Lh | Lh | Lh |
| | 20 | Lh | Lh | Lh |
| | 50 | Lh | Lh | Lh |
| | 100 | Lh | Lh | Lh |
| 275 | 15 | Ll | Ll | Ll |
| | 20 | Lh | Lh | Lh |
| | 50 | Lh | Lh | Lh |
| | 100 | Lh | Lh | Lh |

| | | | |
|---|---|---|---|
| Suction (Pa) | 100 | 200 | 300 |

Lx: x indicates the level of intensity of the lines separated by uncoated zones between low (l), medium (m) and high (h)

TABLE V

| Distance between the | Coating | | | |
|---|---|---|---|---|
| die and the running | speed | Composition 2 | | |
| support (μm) | (m/min) | (Inv.) | | |
| 200 | 50 | H | H | H |
| | 100 | H | H | H |
| | 150 | H | H | H |
| 275 | 50 | H | H | H |
| | 100 | H | H | H |
| | 150 | H | H | H |

| | | | |
|---|---|---|---|
| Suction (Pa) | 100 | 200 | 300 |

H indicates high quality coating, with good uniformity of thickness, without coating faults

The results of tables IV and V show that the coating method according to the invention using the combination of carrageenan, polyvinyl alcohol and guar gum and a support treated by corona discharge without gelatin undercoat layer obtains an ink-receiving layer having a high quality of coating, at a high coating speed of up to 150 m/min. The conventional composition 1 does not obtain a good quality of coating, at any coating speed greater than 15 m/min.

5) Study of the Duration of the Effect of the Treatment by Corona Discharge

The coating method according to the invention was operated using Composition 2. Compositions 2 was coated using a pilot meniscus coating machine, with a conventional loop drier, in which the support runs at a speed of 20 m/min. Composition 2 was applied to a Resin Coated Paper type support having undergone a preliminary treatment by corona discharge by varying the time between the treatment by corona discharge and coating the support, but not including gelatin undercoat layer. The coating conditions were those given in Table I below. Composition 2 was then cooled and dried to form the ink-receiving layer.

The duration of the effect of the treatment by corona discharge is a function of the coating quality and mechanical properties (crackle, adhesion) of the resulting ink-receiving layer.

The coating quality was assessed according to the coating faults. The mechanical adhesion properties were assessed by deforming the film, then cutting it with scissors and by analyzing the cross-section by electron microscopy. The formation of crackle was observed during the drying phase. The results are given in Table VI below according to the coating speed:

TABLE VI

| | Time | | | |
|---|---|---|---|---|
| | between | | | |
| Coating | corona | Coating | | |
| speed | discharge | quality/ | | |
| (m/min) | and coating | Fault | Adhesion | Crackle |
| 20 | 0 | H | H | 0 |
| 20 | 1 hr | H | H | 0 |
| 20 | 24 hr | M | M | P |
| 20 | 1 week | P/Lh | P | H |

Coating quality = P (poor), M (medium), H (high)
Lx: x indicates the level of intensity of the lines separated by uncoated zones between low (l), medium (m) and high (h)
Adhesion = P (poor) for total delamination of the layer; M (medium) for partial delamination; H (high) for high resistance of the layer to mechanical stresses
Crackle = H for the observation of wide crackle on the film surface; P for the observation of small and fine crackle with low frequency.

The results of Table VI clearly show that the effect of the treatment by corona discharge decreases when the time between the treatment and coating increases, and that the ink-receiving layer loses its mechanical properties and its coating quality. The charges created on the support disappear as a function of time. Therefore it is preferable to perform the treatment of the support by corona discharge immediately before coating, in an on-line installation, to obtain maximum coating quality and mechanical properties of the ink-receiving layer.

6) Replacing Pure κ-Carrageenan with a Combination of κ-Carrageenan and ι-Carrageenan or ι-Carrageenan

The coating method according to the invention was operated using Composition 2, 4 and 5. The compositions were coated using a pilot meniscus coating machine, with a conventional loop drier, in which the support runs at a speed of 20 m/min. The compositions were applied on a Resin Coated Paper type support having undergone a preliminary treatment by corona discharge but not including a gelatin undercoat layer. The coating conditions were those given in Table I below. The compositions were then cooled and dried to form the ink-receiving layer.

The coating quality and mechanical properties (crackle, adhesion) of the resulting ink-receiving layers were observed according to the same criteria as those described in section 5. The results are given in Table VII below:

TABLE VII

| Composition | Coating quality | Adhesion | Crackle |
|---|---|---|---|
| 2 | H | H | 0 |
| 4 | H | H | 0 |
| 5 | H | H | 0 |

The results of Table VII clearly show that the coating quality and mechanical properties of the ink-receiving layer are not related to the ratio of kappa to iota carrageenans. Only the rheology of the composition varies: the more ι-carrageenan there is, the higher the viscosity.

7) Coating Method According to the Invention Operated with a Curtain Coating Machine

The coating method according to the invention was operated using Composition 2. Compositions 2 was coated using a pilot curtain coating machine, with a conventional loop drier, in which the support runs at a speed of 140 m/min. Composition 2 was applied on a Resin Coated Paper type support having undergone a preliminary treatment by corona discharge but not including a gelatin undercoat layer. The coating conditions are given in Table VIII below.

TABLE VIII

| Parameters | Values |
|---|---|
| Coating speed | 140 m/min |
| Temperature of the | 50° C. |
| composition | |
| Temperature of the layer | 50° C. |
| Setting temperature | 4° C. |
| Coated width | 0.105 m |

Composition 2 was then cooled and dried to form the ink-receiving layer.

It may be observed that the ink-receiving layer is uniform and has high-quality coating, without fault.

The invention has been described in detail with particular reference to certain preferred embodiments thereof, but it will be understood that variations and modifications can be effected within the spirit and scope of the invention.

1. A coating method of a material intended for forming images by inkjet printing comprising:
a) heating a composition intended to form the ink-receiving layer, said composition comprising at least one polysaccharide, polyvinyl alcohol, guar gum and inorganic particles having neutral or positive surface charge;
b) treating a support by corona discharge;
c) coating said composition directly on said treated support, using a coating machine in which the support runs;
d) cooling the resulting coated, treated support to obtain the thermoreversible gelation of said composition; and
e) drying said coated, treated support.

2. The method of claim 1 wherein said polysaccharide comprises carrageenan.

3. The method of claim 2 wherein the carrageenan is selected from among the group comprising the κ-carrageenans, the ι-carrageenans or a combination of these compounds.

4. The method of claim 2 wherein the carrageenan comprises at least 80% of κ-carrageenan.

5. The method of claim 2 wherein the carrageenan comprises is a pure κ-carrageenan.

6. The method of claim 2 wherein the composition comprises less than 1% by weight of carrageenan.

7. The method of claim 1 wherein the guar gum to carrageenan molar ratio is between 1:20 and 1:5.

8. The method of claim 1 wherein the composition comprises between 0.3% and 5% by weight of polyvinyl alcohol.

9. The method of claim 1 wherein the composition comprises less than 40% by weight of inorganic particles.

10. The method of claim 1 wherein inorganic particles having a neutral surface charge are selected from among the group including calcium carbonate and barium sulfate.

11. The method of claim 1 wherein inorganic particles having a positive surface charge are selected from among the group including zinc oxides, aluminas, zeolites, aluminosilicates, and modified silicas.

12. The method of claim 1 wherein said treating of the support by corona discharge is performed immediately before said coating said composition directly on said treated support.

13. The method of claim 12 wherein the treating of the support by corona discharge is performed on line.

14. The method of claim 1 wherein said support runs at a coating speed greater than or equal to 10 m/min.

15. A coating method of a material intended for forming images by inkjet printing comprising:
a) heating a composition intended to form an ink-receiving layer, said composition comprising at least one carrageenan, polyvinyl alcohol, guar gum and inorganic particles having neutral or positive surface charge;
b) treating a support by corona discharge;
c) coating said composition directly on said treated support, using a coating machine in which the support runs;
d) cooling the resulting material to obtain the thermoreversible gelation of the composition; and
e) drying the material.
